(19) United States
(12) Patent Application Publication
(10) Pub. No.: US 2025/0371283 A1
(43) Pub. Date: Dec. 4, 2025

(54) PRE-PROMPT AND PROMPT ENGINEERING FOR LANGUAGE GENERATION

(71) Applicant: Insight Direct USA, Inc., Chandler, AZ (US)

(72) Inventors: David McCurdy, Centennial, CO (US); Jason Rader, Jacksonville, FL (US)

(21) Appl. No.: 18/911,895

(22) Filed: Oct. 10, 2024

Related U.S. Application Data
(60) Provisional application No. 63/655,944, filed on Jun. 4, 2024.

(51) Int. Cl. G06F 40/40; G06F 16/33; G06F 40/166; G06F 40/284

(52) U.S. Cl. CPC G06F 40/40; G06F 16/3344; G06F 16/3347; G06F 40/166; G06F 40/284

(57) ABSTRACT

A method of automatic pre-prompt generation includes receiving at least one user preference from a user device, modifying a system prompt for a machine-learning language model based on the received at least one user preference to generate a modified system prompt, providing the modified system prompt as an initial input to the machine-learning language model, receiving a natural-language text prompt provided by the user to a chat application on the user device, receiving a user identifier from the user device, querying a first database with the user identifier to retrieve first information, generating a representation of the first information and the natural-language prompt, querying a second database using the representation to retrieve second information, and generating a modified text prompt based on the natural-language prompt, the first information, and the second information.

### CROSS-REFERENCE TO RELATED APPLICATION

This application is a nonprovisional application claiming the benefit of U.S. provisional Ser. No. 63/655,944, filed on Jun. 4, 2024, entitled “PRE-PROMPT AND PROMPT ENGINEERING FOR LANGUAGE GENERATION” by D. McCurdy and J. Rader.

### FIELD OF THE INVENTION

The present disclosure relates to user-specific language generation and, more particularly, systems and methods for creating system prompts based on user and operator preferences and for use with artificial intelligence models for language generation.

### BACKGROUND

Generative artificial intelligence (AI) language models, such as large language models and/or transformer models, are capable of dynamically generating content based on user prompts. Some language models are capable of generating human-like text and can be incorporated into text chat programs in order to mimic the experience of interacting with a human in a text chat. Language models can use a system prompt (sometimes referred to as a pre-prompt or internal prompt) to define roles and provide other instructions and/or constraints for language generation.

### SUMMARY

An example of a method of automatic pre-prompt generation includes receiving, by a user device, an indication of at least one user preference for a user, where the at least one user preference indicative of at least one first characteristic preferred by a user of natural-language outputs generated by a machine-learning language model based on user-provided natural-language text inputs. The method further includes, by a server, receiving the at least one user preference from the user device, modifying a system prompt for the machine-learning language model based on the received at least one user preference to generate a modified system prompt, providing the modified system prompt as an initial input to the machine-learning language model, receiving from the user device a natural-language text prompt provided by the user to a chat application on the user device, receiving a user identifier from the user device, querying a first database with the user identifier to retrieve first information, generating a representation of the first information and the natural-language prompt, querying a second database using the representation to retrieve second information, generating a modified text prompt based on the natural-language prompt, the first information, and the second information. The method further includes providing the modified text prompt as an input to the machine-learning language model to generate a natural-language text output and transmitting the natural-language text output to the user device, and, by the chat application and via the user device, communicating the natural-language text output to the user.

A system for natural language generation includes a first database configured to store first user-specific information, a second database, a user device, and a remote device. The second database is configured to store a plurality of vector embeddings representative of a plurality of natural-language text segments and each vector embedding of the plurality of vector embeddings is representative of one natural-language text segment of the plurality of natural-language text segments. The user device includes a first processor and at least one memory encoded with instructions that, when executed, cause the first processor to receive at least one input indicative of a natural-language text string and provide the natural-language text string as a natural-language text prompt to a chat application operating on the user device. The remote device includes a second processor and at least one second memory encoded with second instructions that, when executed, cause the second processor to receive the natural language text prompt from the user device, receive at least one user preference indicative of at least one first characteristic, preferred by a user, of natural-language outputs generated by a machine-learning language model based on user-provided natural-language text inputs, receive at least one first operator preference indicative of at least one second characteristic, preferred by an operator of the server, of the natural-language outputs, modify a system prompt for the machine-learning language model based on the at least one user preference and the at least one first operator preference, provide the system prompt as an initial input to the machine-learning language model, query the first database with the user identifier to retrieve first information, generate a vector embedding representative of the first information and the natural-language prompt, query the second database using the vector embedding to retrieve second information, and generate a modified text prompt based on the natural-language prompt, the first information, and the second information. The second instructions, when executed, further cause the second processor to provide, subsequent to providing the system prompt, the modified text prompt as an input to the machine-learning language model to generate a natural-language text output and transmit the natural-language text output to the user device.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is a schematic diagram of an example of a system for generating user- and operator-specific system prompts and further for generating natural language using layered database queries in combination with to those system prompts.

FIG. 2 is a schematic diagram of another example of a system for generating user- and operator-specific system prompts and further for generating natural language using layered database queries in combination with those system prompts.

FIG. 3 is a flow diagram of an example of a method of generating user- and operator-specific system prompts and further for generating natural language using layered database queries in combination with those system prompts suitable for use by the systems of FIGS. 1-2.

While the above-identified figures set forth one or more examples of the present disclosure, other examples are also contemplated, as noted in the discussion. In all cases, this disclosure presents the invention by way of representation and not limitation. It should be understood that numerous other modifications and examples can be devised by those skilled in the art, which fall within the scope and spirit of the principles of the invention. The figures may not be drawn to scale, and applications and examples of the present invention may include features and components not specifically shown in the drawings.

### DETAILED DESCRIPTION

The present disclosure relates to systems and methods for generating and using user- and operator-specific system prompts and, further, for generating natural language using user-specific context injection in combination with user- and operator-specific system prompts. The user- and operator-specific specific system prompts generated using the methods and systems herein can be used to improve natural-language responses generated by machine-learning language models in response to user-generated natural-language prompts. Further, the user-specific context injection described herein decreases the likelihood that machine-generated natural-language responses include fabricated or erroneous information (e.g., a “hallucination”) and further increases the likelihood that machine-generated natural-language responses are user-relevant. The combination of both user-specific system prompts and context injection greatly increase the likelihood that machine-generated natural-language responses are relevant to user queries as well as unstated (i.e., in a user prompt) user goals and interests, and further allow for incorporation of operator preferences into system prompt information to increase the likelihood that those machine-generated natural-language responses also are relevant to operators of machine-learning natural-language models and chat services that utilize those models.

In particular, user-specific system prompts increase the likelihood that machine-generated natural-language is relevant to a user, improving user experience and increasing user retention. Operator-specific system prompts allow an operator's (e.g., an operator of a language generation service based on a machine-learning language model) preferences, goals, desires, etc. to also be reflected in language generation and for the language generated by a machine-learning language model to at least partially incorporate those preferences, goals, desires, etc. As will be explained in more detail subsequently, the use of system prompts that incorporate both user and operator preferences enables language generation that improves user experience while enabling operators of machine-learning language model-powered language generation services to advance specific goals in language generation and seek out revenue streams related to those goals.

The use of user-specific context injection yet further increases the likelihood that machine-generated natural language is relevant to individual users of a language generation service powered or facilitated by a machine-learning language model. As will be explained in more detail subsequently, the systems and methods disclosed herein use enable the injection of user-specific information into a user-supplied prompt for querying a vector database. The information retrieved from the vector database and the user-specific information can then be used to supplement the original user prompt prior to natural-language text generation by the language model. The systems and methods disclosed herein significantly improve the relevance of vector database queries to an individual user and, accordingly, can be used to reduce the quantity of text provided to a language model as context while providing similar or superior improvements to hallucination/fabrication reduction as systems and methods using significantly more text information as context for natural-language text generation. Advantageously, reducing the quantity of text used as input to a language model can provide concomitant reductions to processing power and time required to generate a natural-language output.

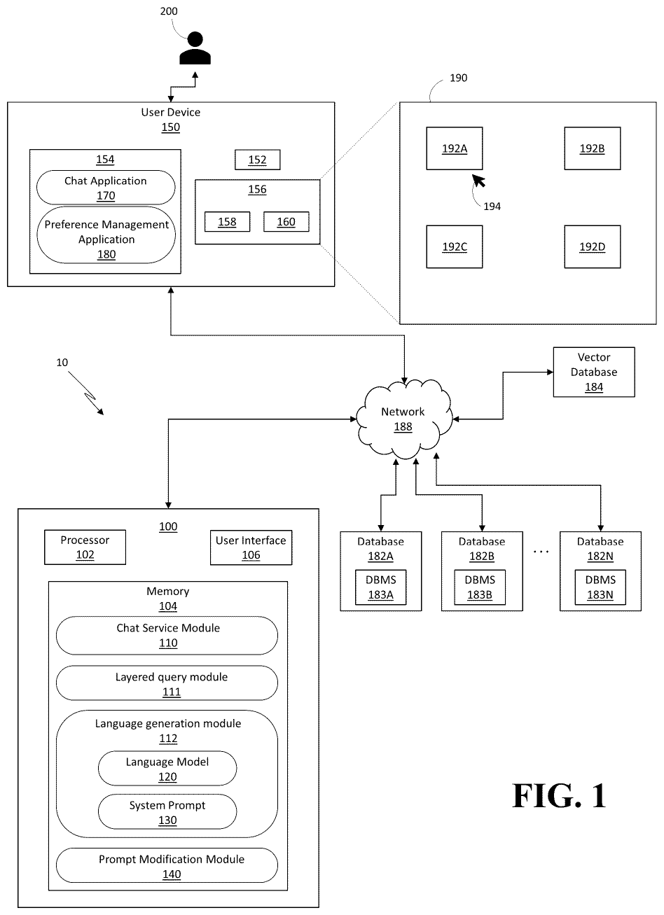

FIG. 1 is a schematic depiction of system 10, which is a system for generating natural-language responses to user-generated prompts. System 10 includes server 100, user device 150, databases 182A-N, vector database 184, and network 188. Server 100 includes processor 102, memory 104, and user interface 106. Memory 104 stores chat service module 110, layered query module 111, language generation module 112, and prompt modification module 140. Language generation module 112 includes language model 120 and system prompt 130. User device 150 includes processor 152, memory 154, and user interface 156. User interface 156 optionally includes both input device 158 and output device 160. Memory 154 includes chat application 170 and preference management application 180. Databases 182A-N organize data using database management systems (DBMSs) 183A-N, respectively. Preference management application 180 provides graphical user interface 190, which can be communicated to a user via user interface 156. Graphical user interface 190 includes graphical objects 192A-N, which are selectable using pointer 194. FIG. 1 also depicts user 200.

System 10 operates a chat service that uses a machine-learning language model to generate natural-language responses to user-generated prompts. As will be explained in more detail subsequently, the natural-language responses generated by server 100 are based in part on user preferences stored to user device 150 and/or one or more of databases 182A-N as well as operator preferences stored to one or more of databases 182A-N. As referred to herein, a “user preference” is a preference of a user of the chat service operated by server 100 (e.g., 200) regarding one or more characteristics of the outputs produced by server 100. As referred to herein, an “operator preference” is a preference of the operator of the chat service (e.g., the operator of server 100) regarding one or more characteristics of the outputs produced by server 100.

User preference and operator preference information is used to generate a user-specific system prompt, allowing the content of natural-language responses generated subsequently by a machine-learning language model to reflect content-generation preferences for both the user and the chat-service operator. The system prompt can be changed or modified for each user accessing language-generation functionality of server 100 (e.g., for each instance of language-generation software operating on server 100), allowing for robust incorporation of user and operator preferences in language generation.

Further and as will be explained in more detail subsequently, system 10 uses a layered query approach to incorporate retrieve contextual information that can be used to augment user prompts provided to a language model, reducing fabrications (e.g., AI hallucinations) created by the language model and also increasing both the accuracy of responses generated by the language model as well as the value of those responses for users. The layered query approach detailed herein uses successive database queries to retrieve information from multiple databases. More specifically, the layered query approach detailed herein incorporates information retrieved from one or more initial queries of structured and/or semi-structured databases to augment subsequent queries made to one or more vector databases. All information retrieved (i.e., data retrieved from both structured/semi-structured and vector databases) can be incorporated into the initial user prompt to provide context to a language model that generates responses for natural-language chat applications.

Server 100 is connected to network 188 via one or more wired and/or wireless connections and is able to communicate with user device 150 via network 188. In some examples, server 100 can be referred to as a “remote device” and/or a “remotely-connected device.” Although server 100 is generally referred to herein as a server, server 100 can be any suitable network-connectable computing device for performing the functions of server 100 detailed herein.

Processor 102 can execute software, applications, and/or programs stored on memory 104. Examples of processor 102 can include one or more of a processor, a microprocessor, a controller, a digital signal processor (DSP), an application specific integrated circuit (ASIC), a field-programmable gate array (FPGA), or other equivalent discrete or integrated logic circuitry. Processor 102 can be entirely or partially mounted on one or more circuit boards.

Memory 104 is configured to store information and, in some examples, can be described as a computer-readable storage medium. Memory 104, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 104 is a temporary memory. As used herein, a temporary memory refers to a memory having a primary purpose that is not long-term storage. Memory 104, in some examples, is described as volatile memory. As used herein, a volatile memory refers to a memory that that the memory does not maintain stored contents when power to the memory 104 is turned off. Examples of volatile memories can include random access memories (RAM), dynamic random access memories (DRAM), static random access memories (SRAM), and other forms of volatile memories. In some examples, the memory is used to store program instructions for execution by the processor. The memory, in one example, is used by software or applications running on server 100 (e.g., by a computer-implemented machine-learning model) to temporarily store information during program execution.

Memory 104, in some examples, also includes one or more computer-readable storage media. Memory 104 can be configured to store larger amounts of information than volatile memory. Memory 104 can further be configured for long-term storage of information. In some examples, memory 104 includes non-volatile storage elements. Examples of such non-volatile storage elements can include, for example, magnetic hard discs, optical discs, floppy discs, flash memories, or forms of electrically programmable memories (EPROM) or electrically erasable and programmable (EEPROM) memories.

User interface 106 is an input and/or output device and/or software interface, and enables an operator to control operation of and/or interact with software elements of server 100. For example, user interface 106 can be configured to receive inputs from an operator and/or provide outputs. User interface 106 can include one or more of a sound card, a video graphics card, a speaker, a display device (such as a liquid crystal display (LCD), a light emitting diode (LED) display, an organic light emitting diode (OLED) display, etc.), a touchscreen, a keyboard, a mouse, a joystick, or other type of device for facilitating input and/or output of information in a form understandable to users and/or machines.

User device 150 is an electronic device that a user (e.g., user 200) can use to access network 188 and functionality of server 100 (i.e., via network 188). User device 150 includes processor 152, memory 154, and user interface 156, which are substantially similar to processor 102, memory 104, and user interface 106, respectively, and the discussion herein of processor 102, memory 104, and user interface 106 is applicable to processor 152, memory 154, and user interface 156, respectively. User device 150 includes networking capability for sending and receiving data transmissions via network 188 and can be, for example, a personal computer or any other suitable electronic device for performing the functions of user device 150 detailed herein. Memory 154 stores software elements of chat application 170 and preference management application 180, which will be discussed in more detail subsequently and particularly with respect to the function of chat service module 110 of server 100.

User interface 156 optionally includes one or both of input device 158 and output device 160. Input device 158 is a device that a user (e.g., user 200) can use to provide inputs to the program(s) of user device 150. Input device 158 can be, for example, a touchscreen, a keyboard, a mouse, a joystick, etc. A user can use input device 158 to, for example, provide inputs to chat application 170 and preference management application 180. Output device 160 is a device for communicating outputs from the program(s) of user device 150 to a user (e.g., user 200). Output device 160 can include, for example, one or more of a display, a speaker, or any other suitable device for conveying outputs from the program(s) of user device 150.

Databases 182A-N are electronic databases that are directly connected to server 100 and/or are connected to server 100 via a local network. Each of databases 182A-N includes machine-readable data storage capable of retrievably housing stored data, such as database or application data. In some examples, one or more of databases 182A-N includes long-term non-volatile storage media, such as magnetic hard discs, optical discs, flash memories and other forms of solid-state memory, or forms of electrically programmable memories (EPROM) or electrically erasable and programmable (EEPROM) memories. Databases 182A-N organize data using DBMSs 183A-N, respectively, and each of databases 182A-N can include a processor, at least one memory, and a user interface that are substantially similar to processor 102, memory 104, and user interface 106 of server 100. In at least some examples, one or more of databases 182A-N are relational databases. Each of databases 182A-N a structured database (e.g., a table or relational database) or a semi-structured database (e.g., a hierarchical and/or nested database). Databases 182A-N store data describing users who access server 100 and the software modules thereof (e.g., user 200).

Each of databases 182A-N can store, for example, descriptive user information, user preference information, and/or operator preference information., such as user purchase history, user device information, or another suitable type of information for describing a user. Descriptive user information stored by one or more of databases 182A-N can include, for example, one or more recent purchases made by the user, an account type and/or level held by the user, and/or user financial information, among other options. User preference information stored by one or more of databases 182A-N can include, for example, user subscription information (e.g., to a subscription service), preferred vendor information, and/or advertisement preference information, among other options. Databases 182A-N can be configured to be queryable using user identifiers, such as user credentials (e.g., credentials for accessing server 100 functionality, such as a username or password), account numbers, and/or other suitable user descriptors to retrieve stored user information.

Operator preference information stored by one or more of databases 182A-N can include, for example, preferred vendor information and/or advertisement preference information, among other options. In some examples, databases 182A-N can store custom operator preference information for each known user of server 100, such that identifying information for a user (e.g., a user identifier) can be used to query one or more databases 182A-N to return the operator preference information selected for that particular user and/or a group of which the user is a member. Advantageously, in these examples, operator preference information can be customized on a user-by-user basis, such that different operator preferences can be pre-determined and applied to different users and/or user groups accessing server 100. In other examples, operators can define preferences globally, such that the same operator preference information is used in language generation for all or substantially all users accessing server 100 functionality.

DBMSs 183A-N are database management systems. As used herein, a “database management system” refers to a system of organizing data stored on a data storage medium. In some examples, a database management system described herein is configured to run operations on data stored on the data storage medium. The operations can be requested by a user and/or by another application, program, and/or software. The database management system can be implemented as one or more computer programs stored on at least one memory device and executed by at least one processor to organize and/or perform operations on stored data.

Vector database 184 is an electronic database that stores vector information representative of natural-language text. The vectors stored in vector database 184 are embedded as vectors using an embedding model/algorithm that transforms natural-language text into vectors representative of the text. The vectors can represent the words of the natural-language text (e.g., word vectors) and/or any other suitable element of the text. The natural-language text represented by the vectors of vector database 184 can be, for example, chat logs collected by chat service module 110 and/or chat application 170. The vectors of vector database 184 can represent any suitable length of text, such as sentences, paragraphs, etc. In at least some examples, the vectors of vector database 184 represent sentences within messages and/or entire messages sent through the chat service operated by chat service module 110.

For example, the vectors of vector database 184 can represent chat histories, both including user queries and/or responses generated by server 100. For example, chat service module 110 and/or chat application 170 can collect and/or store a chat history of all messages sent within a particular time period, including all prompts submitted by a user to chat application 170 as well as all responses generated by the programs of server 100 to those prompts. Server 100 and/or vector database 184 can separate the chat history into individual messages and/or sentences (i.e., in examples where a message includes more than one sentence), and store vector embeddings of those text segments in vector database 184.

Additionally and/or alternatively, vector database 184 can store vector embeddings of pre-generated (e.g., by a human operator) text constructed for providing context to the program(s) of language generation module 112. For example, vector database 184 can store vector embeddings of templates, forms, pre-generated response text, and/or any other suitable pre-generated text that can be used by a machine-learning language model that can be used for structure and/or

In some examples, vector database 184 can be partitioned such that different partitions of vector database 184 store vector embeddings of text specific to particular user identifiers (e.g., to particular users, to particular items purchasable by users, to particular groups of users, etc.). The user identifier(s) for a user can be used to identify one or more relevant partitions of vector database and those relevant partition(s) can be queried to retrieve user-specific natural-language text information.

To query vector database 184, server 100 and/or vector database 184 can generate a vector embedding of query text and compare that vector to the vectors stored to vector database 184. The vector embedding of the query text is referred to herein as a “query vector” and the vectors of the database are referred to herein as “database vectors.” The query vector can be generated using the same embedding algorithm and/or have the same number of dimensions as the database vectors (i.e., the vectors of vector database 184). Vectors stored to vector database 184 having a similarity score above a particular threshold and/or having the highest overall similarity to the query vector can be returned in response to the query. Vector similarity can be assessed by cosine similarity, cartesian similarity, and/or any other suitable test for assessing vector similarity. The corresponding raw data (i.e., the raw, natural-language text information) represented by the returned vectors can then be retrieved and provided to server 100.

Network 188 is a network suitable for connecting and facilitating network communication between server 100, user device 150, databases 182A-N, and vector database 184. Network 188 can include any suitable combination of local network and wide area network (WAN) elements or components to connect server 100, user device 150, databases 182A-N, and vector database 184. In some example, the wide area network can be or include the Internet. For example, server 100 can be connected to databases 182A-N and/or vector database 184 via a local network and server 100 can be connected to user device 150 via a WAN. As a further example, server 100 can be connected to all of user device 150, databases 182A-N, vector database 184 via a WAN. In yet further examples, server 100 can be connected to some of databases 182A-N and/or vector database 184 via a WAN and others of databases 182A-N and/or vector database via a local network.

Chat service module 110 is a software module of server 100 and includes one or more programs for running a chat service. The chat service operated by chat service module 110 is accessible by chat application 170 and enables users to receive machine-generated natural-language text replies to user-generated text prompts. Chat service module 110 runs services used and/or invoked by chat application 170 and in operation provides user-generated prompts to layered query module 111 and to language module 112, and further provides natural-language text replies generated by the program(s) of language module 112 to user device 150. Natural-language text replies generated by server 100 and transmitted to user device 150 in this manner can communicated to a user via chat application 170. For example, chat application 170 can cause output device 160 to display an indication, such as a text representation, of the natural-language text reply to allow a user (e.g., user 200) to read the reply and, in some examples, formulate a subsequent prompt.

While the service operated by chat service module 110 is generally referred to as a “chat service” herein, in some examples, the service operated by chat service 110 does not represent or relate user prompts and machine-generated replies as a natural-language text conversation. For example, the chat service operated by chat service module 110 can be an API or one or more programs invokable via an API for accessing functionality of language generation module 112, such that chat application 170 functions as an interface, program, etc. for accessing calling functions of the API.

Layered query module 111 is a software element of server 100 and includes one or more programs for performing layered queries of structured or semi-structured databases and vector databases. As will be explained in more detail subsequently, layered query module 111 is configured to retrieve user-specific information from a structured or semi-structured database (e.g., one or more of databases 182A-N) based on user identifier information. Layered query module 111 is further configured to retrieve text string information from a vector database (e.g., vector database 184) based on both a received user prompt and the retrieved user-specific information. The sequential querying of structured/semi-structured databases and vector databases as well as the use of information retrieved from the structured/semi-structured database to formulate a query to a vector database is referred to herein as a “layered query” or a “layered database query.”

The program(s) of layered query module 111 can generate queries for databases 182A-N and vector database 184. Layered query module 111 is configured to generate database queries based on user identifier information and, further, based on user prompts supplied via a chat client 148, 198. The user identifier information can be, for example, credentials used to access server 100 functionality and/or another identifier retrieved based on user credential information. Layered query module 111 can optionally be configured with a vector embedding algorithm for generating query vectors for vector database 184 or another suitable vector database based on natural-language text information and information retrieved from a structured or semi-structured database.

Language generation module 112 is another software module of server 100 and includes one or more programs for automated natural-language text generation. Language generation module includes language model 120 and system prompt 130. Language model 120 is a machine-learning language model trained to generate natural-language outputs (or tokenized representations thereof) from natural-language inputs (or tokenized representations thereof). In some examples, language model 120 can include one or more programs for converting natural-language inputs into numeric representations and for converting numeric representations of text information into natural-language text. For example, language generation module 112 can include a tokenization algorithm for generating tokens representative of text (e.g., encoding user inputs) and for generating natural-language text based on token information (e.g., decoding machine-generated tokens). Language model 120 can be a language model such as, for example, a large language model and/or a transformer model.

System prompt 130 is natural-language text and/or a tokenized representation of natural-language text (i.e., one or more tokens representative of natural-language text) and provides instructions to language model 120 for generating natural-language responses to user-generated prompt text. System prompt 130 can be stored as, for example, a natural-language text string, an encoded text string (e.g., encoded as one or more tokens), or any other suitable format. System prompt 130 is generally referred to herein as a “system prompt,” but in other examples system prompt 130 can be referred to as a “pre-prompt” or “internal prompt.” Language generation module 112 includes one or more programs that provide system prompt 130 to language model 120 prior to providing user prompts. The process of providing system prompt 130 to language model 120 is generally referred to herein as “system prompting,” but in other examples can be referred to as “pre-prompting” or “internal prompting.” In some examples, server 100 can store a default or standard system prompt 130 that can be modified by user device 150 and/or server 100 to incorporate user preference information.

Prompt modification module 140 is a software application of server 100 that includes one or more programs for modifying system prompt 130 according to both user and operator preferences. The program(s) of prompt modification module 140 can receive user preferences from preference management application 180 as well as operator preferences from one or more of databases 182A-N as one or more natural-language words and/or as one or more encodings representative of natural-language words (e.g., one or more tokens). The program(s) of prompt modification module 140 can then modify system prompt 130 according to those received natural-language words and/or encodings by, for example, replacing all or part of a pre-existing or default system prompt with the received natural-language words. In further examples, the program(s) of prompt modification module 140 can then modify system prompt 130 by adding the received natural-language words and/or encodings to the natural-language words and/or encodings of a pre-existing, default, or other preferred system prompt.

Chat application 170 is a software application of user device 150 for receiving user prompts, providing those prompts to server 100, receiving responses from server 100, and communicating those responses to the user (e.g., user 200). Chat application 170 can be, in some examples, a web browser for accessing a web application hosted by server 100 that uses the functionality of chat service module 110. Additionally and/or alternatively, chat application 170 can be a specialized software application for interacting with chat service module 110 of server 100. Chat application 170 can be selectively operated by user device 150. For example, a user can provide one or more inputs to user device 150 to cause user device 150 to begin operating chat application 170. A user can provide user prompts by, for example, typing a natural-language phrase or sentence using a keyboard or a similar input device.

In some examples, chat application 170 can include a graphical user interface including one or more selectable graphical elements, such as one or more clickable elements and/or graphical buttons, representative of a natural-language text phrases that can be used as prompts for language model 120. A user can provide prompts to chat application 170 by interacting with the graphical elements of chat application 170 to select the natural-language text phrase(s) the user wants to use as an input to or prompt for language generation. Chat application 170 can then transmit the selected natural-language text phrase(s) to server 100 as the prompt for language generation by language model 120.

In some examples, chat application 170 can include a graphical user interface that displays a chat history between the user and server 100, such that a user can view previous user-submitted prompts and machine-generated replies created by server 100. Chat application 170 can display prior text replies as, for example, a conversation history or in any other suitable format. In some examples, chat 170 can also display only the most-recent language generated by server 100.

Preference management application 180 is a software application of user device 150 for managing user preferences and for creating system prompt or pre-prompt information that can be used to modify system prompt 130 to incorporate user preferences. Preference management application 180 manages and stores (e.g., to memory 154, memory 104, etc.) user preferences for use in system prompt 130. Preference management application 180 can store user preferences as, for example, one or more text strings that can be provided to server 100 to be used as a system prompt for subsequent natural language generation by language model 120 for the user. Additionally and/or alternatively, preference management application 180 can store user preferences as encoded text that can be provided to server 100 to be used as a system prompt. In these examples, user device 150 can optionally include an encoding algorithm (e.g., a tokenizing algorithm) suitable for generating encoded text usable by language model 120 (i.e., of the type of encoded text on which language model 120 was trained). In at least some examples, preference management application 180 is a software plugin or extension for a web browser. Preference management application 180 can store user preferences (e.g., to memory 104, memory 154, etc.) such that user preference information can be retrieved after a period in which the language generation functions of server 100 are inactive, allowing user preferences to be defined ahead of language generation and to be retrieved when program(s) of language generation module 112 are executed to generate natural language using language model 120.

A user can interact with software elements of preference management application 180 to define preferences in the outputs of language generation. Preference management application 180 can store those user preferences to user device 150 and/or server 100 for use by preference management module 140 to modify system prompt 130. In some examples, preference management application 180 can store user preferences to a database and/or another suitable device connected to network 188. In yet further applications, preference management application 180 can provide user preferences to server 100 and server 100 can store those preferences to one or more of databases 182A-N. Server 100 can retrieve user preferences for system prompt modification by, for example, querying the relevant database(s) with a user identifier for a user submitting a natural-language prompt.

Preference management application 180 and/or one or more programs of server 100 (e.g., the program(s) of prompt modification module 140) can generate a user-specific system prompt and/or a natural-language text phrase representative of the user's preferences from the user-preference information. For example, preference management application 180 can generate a user-specific natural-language text phrase (or an encoding representative thereof) based on the preference information provided by the user and can provide that natural-language text phrase (or encoding representative thereof) to server 100. As a further example, preference management application 180 can transmit preference information to server 100 and server 100 can generate a user-specific natural-language text phrase based on the preference information.

Prompt modification module 140 and/or another suitable program of server 100 can retrieve natural-language text and/or encodings representative thereof from one or more of databases 184A-N that represent, describe, etc. operator preferences for language generation for the user. Operator preference can be defined globally such that the same preferences apply for each user of the chat service operated by server 100 and/or server 100 can retrieve user-specific operator preferences. User and operator preferences can optionally each be retrieved based on one or more user identifiers for the user, such as a user name, account identifier, internet protocol address, and/or any other suitable credential or identifier.

Prompt modification module 140 can then modify system prompt 130 based on the received user and operator preference information, such that the modified system prompt 130 includes information describing both user preference(s) for language generation and operator preference(s) for the same language generation. Language model 120 can then use the modified system prompt 130 as an initial input prior to other prompts to improve the relevance of the text outputs generated by language model 120 to user and operator preferences, needs, requirements, etc.

Preference management application 180 can automatically transmit preference information when the user transmits a natural-language prompt via chat application 170. Additionally and/or alternatively, server 100 can retrieve user preference information (e.g., as natural-language text, one or more encodings, etc.) and/or operator preference information (e.g., as natural-language text, one or more encodings, etc.) when server 100 receives a user prompt. In some examples, server 100 can also retrieve user preference and/or operator preference information when server 100 server 100 authenticates user access to language generation module 112 (e.g., based on user account credentials).

Preference management application 180 can be configured to solicit (i.e., from a user) and store (e.g., to memory 154) any suitable information describing user preferences for the outputs of language model 120. For example, the user preference(s) managed by preference management application 180 can include user membership information, user subscription information (e.g., to a subscription service), preferred vendor information, and/or advertisement preference information, among other options. In some examples, the user preference(s) managed by preference management application can also include suitable data sources by context injection (e.g., retrieval augmented generation) by language generation module 112.

Operator preferences stored by one or more of databases 184A-N can describe preferred vendor information and/or advertisement preference information, among other options. Operator preferences can be managed by prompt modification module 140 and/or any other suitable program of server 100.

Graphical user interface 190 is an optional element of user device 150 and is graphical user interface for defining user preferences and is operated by the program(s) of preference management application 180. Graphical user interface 190 can be displayed by, for example, user interface 156 (e.g., output device 160) of user device 150. Graphical user interface 190 includes graphical objects 192A-N that a user can use to interact with preference management application 180 and to define user preferences. A user can control pointer 194 via, for example, input device 158 to interact with graphical objects 192A-N to define user preferences. Graphical objects 192A-N can be, for example, one or more checkboxes or radio buttons that a user can select to define user preferences for preference management application 180. In other examples, a user can input one or more text strings defining user preferences. Preference management application 180 can store the text string as user preference information for the user and/or can extract relevant text from the text string and store the extracted text as user preference information for the user. For example, preference management application 180 can extract one or more keywords and/or can use a natural language processing algorithm to identify and extract relevant information from the text string (e.g., intent and/or entity information). The use of graphical elements of to define user preferences in preference management application 180 can advantageously increase ease of use of preference management application 180.

In some examples, server 100 can also operate a graphical user interface that an operator of server 100 can use to define operator preferences. Server 100 can then store operator preference information to memory 104 and/or one or more databases (e.g., one or more of databases 182A-N), and can retrieve operator preference information subsequently to modify system prompt 130. The graphical user interface can be any suitable graphical user interface and in some examples can be substantially similar to graphical user interface 190.

In some examples, server 100 can also operate a graphical user interface that an operator of server 100 can use to define operator preferences. Server 100 can then store operator preference information to memory 104 and/or one or more databases (e.g., one of databases 182A-N), and can retrieve operator preference information subsequently to modify system prompt 130. The graphical user interface can be any suitable graphical user interface and in some examples can be substantially similar to graphical user interface 190.

In operation, chat service module 110 receives a user prompt from a user via chat application 170. The prompt is natural-language text and, in some examples, includes one or more requests. The chat client provides the user prompt to server 100. The chat client also provides a user identifier for the user. The user identifier can be, for example, access credentials for validating that the user is approved to access functionality of server 100, or any other suitable identifier for the user, such as the user's name, an account number for the user (e.g., a business account number), etc. In some instances, the user identifier can be provided within the natural language text of the prompt; in other instances, the user identifier can be provided by the user separately, or retrieved based on a source of the prompt, user permissions, or other contextual information.

The program(s) of layered query module 111 uses the user identifier received from the chat client to query a structured database or semi-structured database (e.g., one or more of databases 182A-N) to retrieve user-specific information for the user. The queried database stores information in a structure that is queryable with user identifiers and is able to return additional information describing the user based on the user identifier. As described previously, the user-specific information can be, for example, one or more recent purchases made by the user, an account type and/or level held by the user, user financial information, etc. The program(s) of layered query module 120 can combine the retrieved and create a vector embedding of the retrieved information and the user prompt to query vector database 189. Additionally and/or alternatively, the program(s) of layered query module 120 can provide the retrieved information and the user prompt to vector database 189 and one or more program(s) of vector database 189 can create the vector embedding for querying vector database 189. Querying vector database 189 retrieves natural-language text represented by vectors identified by the query, and vector database 189 and provides the retrieved natural-language text to server 100. The retrieved natural-language text, the user prompt, and in some examples the information retrieved from the structured/semi-structured database(s) can be used to create a modified user prompt for language generation by language generation module 112.

Upon user prompt submission and/or at a point prior to prompt submission by a user, server 100 receives user preference information from preference management application 180 (e.g., by requesting user preference information from preference management application 180) and also receives operator preference information (e.g., by querying one of databases 182A-N). Prompt modification module 140 uses the received user and operator preference information to modify system prompt 130. After system prompt 130 has been modified according to user and operator preference information, language generation module 112 provides the modified user prompt (i.e., the prompt generated following layered queries by layered query module 111) as an input to language module 120. Chat service module 110 can then provide the language output by language model 120 (or natural language represented by an encoding output by language model 120) to chat application 170. Chat application 170 can communicate the language output to the user as a response to the user's original natural-language prompt as, for example, a graphical text representation of the natural-language output.

In some examples, the program(s) of layered query module 111 can query multiple structured and semi-structured databases using the user identifier and can use retrieved information from multiple databases to create the augmented prompt used to query vector database 189. Additionally and/or alternatively, the program(s) of layered query module 120 can query multiple structured or semi-structured databases with the user identifier and use only a subset of the retrieved information to query vector database 189. In these examples, the additional retrieved information can be provided to language generation module 112 as context for response generation.

System 10 confers numerous advantages. Server 100 advantageously leverages user- and operator-specific system prompt information to dynamically modify system prompt 130 of server 100 with a custom system prompt. For example, if a user prompt inquires for recommendations for a particular type of product and if the user preferences stored by preference management application 180 define a range of preferred vendors (i.e., preferred by the user) for that type of product, providing a user-specific system prompt defining those vender preferences can decrease the likelihood that an output of language model 120 includes a recommendation for a non-preferred vendor, thereby improving user satisfaction with the output of language model 120. The system prompts herein are also able to reflect operator preferences in addition to user preferences. The operator preferences represented in the system prompts created and used by server 100 can enable an operator to use the language generation from language model 120 to pursue operator-specific goals, interests, desires, etc. For example, an operator of a chat service can use system 10 to fulfill one or more third-party advertisement or sponsorship obligations. Language generation using a modified system prompt 130 that includes information related to the third-party advertisement or sponsorship obligation(s) can allow language generated by language model 120 to include information related to those advertiser(s) and/or sponsor(s).

System 10 can be used to record and use a wide variety of user and operator preferences and the prior examples are merely illustrative examples of the advantages conferred by preference-driven system prompts. system 10 and, in particular, the generation of custom system prompts using information collected by preference management application 180. As the prior examples illustrate, the use of user and operator preferences to generate system prompts advantageously improves user satisfaction with the outputs of language model 120 by increasing the relevance of those outputs to individual users.

Notably, including both user-specific and operator-specific information in a system prompt provides further improvements over the inclusion of only user-specific information or operator-specific information in a system prompt. In particular, the inclusion of both user-specific and operator-specific information in a system prompt enables the language generated by a language model using the system prompt to appear at least partially user-specific rather than based solely on operator preferences or demands. For example, language generated using the system prompts described herein is likely to reflect user preferences for a particular vendor, service provider, etc. while also reflecting operator preferences for a (possibly different) vendor, service provider, etc., increasing user-relevance of language generated by a machine-learning language model and improving user retention for a service powered by such a machine-learning language model (e.g., chat service 110) as compared to services that only incorporate operator preference information.

The layered database query approach outlined herein also provides numerous advantages and over conventional database retrieval approaches for context injection, such existing retrieval-augmented generation (RAG) methods. The use of the information retrieved from database(s) 182A-N and vector database 184 provides additional context to the trained, computer-implemented machine-learning model and improves the accuracy of the natural-language response generated thereby, providing improvements to the reduction of AI hallucinations or fabrications that can occur during natural-language text generation by machine-learning language models. The use of user-specific information in combination with user prompts to query vector database 189 increases the likelihood that the query returns user-relevant information, improving user experience with and user retention by the chat service operated by server 100. The layered query approach outlined herein accordingly reduces the likelihood that irrelevant or extraneous information is retrieved and used to augment user prompts for context injection and, further, can reduce the total amount of text retrieved by querying vector database 189 at a given similarity threshold. Advantageously, reducing the overall quantity of text provided to a language model (or other computer-implemented machine-learning model configured to generate natural-language) as context (e.g., via RAG or a RAG-like approach) can reduce the computational cost associated with generating response text and, accordingly, can reduce the overall time required to generate the response text. Notably, by improving the likelihood that a vector database query returns user-relevant information, the layered query approach outlined herein can reduce computational cost while provided similar or superior hallucination/fabrication reduction as existing context injection techniques that use conventional vector database retrieval. Reducing time required to generate response text can also advantageously reduce lag perceived by users between prompt submission (i.e., via chat clients 148, 198) and response receipt (i.e., of a natural-language response generated by language generation module 112).

FIG. 1 depicts only one user device (i.e., user device 150) for illustrative convenience and for clarity, but in other examples, system 10 can include any number of user devices. System 10 can, for example, include multiple analogous user devices serving parallel functions, e.g. at different locations and/or for different users. Additionally or alternatively, functions of user device 150 (and any analogous user devices) can be distributed across multiple separate hardware devices accessible locally and/or via network 188. Similarly, while server 100 is depicted as a single device in FIG. 1, in other examples, server 100 can include multiple devices (e.g., multiple servers) configured to perform the functions of server 100.

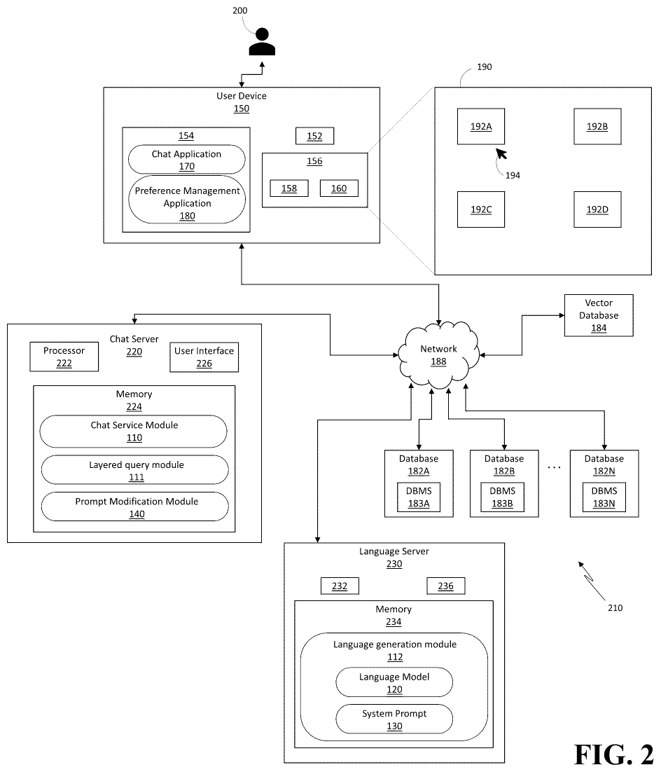

FIG. 2 is a schematic depiction of system 210, which is another example of a system for generating natural-language responses to user-generated prompts. System 210 is substantially similar to system 10, but also includes chat server 220 and language server 230 instead of server 100. Chat server 220 includes processor 222, memory 224, and user interface 226, which are substantially similar to processor 102, memory 104, and user interface 106, respectively, and the discussion herein of processor 102, memory 104, and user interface 106 is applicable to processor 222, memory 224, and user interface 226, respectively. Language server 230 includes processor 232, memory 234, and user interface 236, which are substantially similar to processor 102, memory 104, and user interface 106, respectively, and the discussion herein of processor 102, memory 104, and user interface 106 is applicable to processor 232, memory 234, and user interface 236, respectively. In system 210, memory 224 stores chat service module 110, layered query module 111, and prompt modification module 140, and memory 234 stores language generation module 112.

In system 210, chat server 220 includes chat service module 110, layered query module 111, and prompt modification module 140. Chat server 220 operates the chat service accessed by chat application 170, performs layered queries of databases 182A-N and vector database 184, and modifies system prompt 130 (or causes language server 230 to modify system prompt 130) according to user and operator preferences. Language server 230 includes language generation module 112 and performs language generation to create natural-language responses for chat server 220. Chat server 220 is configured to access the language generation functionality of language server 230 and can send one or more commands to language server 230 (e.g., one or more API calls) to cause language server 230 to generate natural-language responses to user prompts. Chat server 220 can also issue one or more commands to language server 230 to modify system prompt 130. Chat server 220 can request user preference information from user device 150 and/or user device 150 can transmit user preference information when a user sends a prompt and/or when a user accesses chat application 170. Each of chat server 220 and language server 230 can operate an API exposed to allow other devices (e.g., user device 150 and chat server 220, respectively) to access the functionality of chat server 220 and/or language server 230.

In operation of system 210, user device 150 sends user preferences and user-generated natural-language prompts to chat server 220. Chat server 220 accesses functionality of language server 230 to modify system prompt 130 based on user and operator preferences. Chat server 220 also queries one or more of databases 182A-N and vector database 184 using layered query module 111. Chat 220 then accesses the functionality of language server 230 to provide an input to language model 120 including the user query and the retrieved information to further generate a natural-language response to user-submitted prompts or queries. Chat server 220 then provides the generated natural-language response to user device 150.

System 210 confers several advantages. System 210 confers the advantages of system 10 discussed previously. Further, system 210 is able to confer the advantages of system 10 in situations where it is advantageous for chat server 220 and language server 230 to be separate devices and, further, in examples where those separate devices are separated by large geographic distances. As a specific example, system 210 enables the advantages of system 10 where the entity operating the chat service (i.e., operating chat server 220) is a different entity than the entity operating language server 230. Chat server 220 can receive preferences form preference management application 180 and use those preferences to modify the system prompt of a third-party language server 230 to perform user-specific language generation according to the present disclosure.

FIG. 2 depicts only one user device (i.e., user device 150) for illustrative convenience and for clarity, but in other examples, system 210 can include any number of user devices. Similarly, while chat server 220 and language server 230 are each depicted as a single device in FIG. 2, in other examples, each of chat server 220 and language server 230 can include multiple devices (e.g., multiple servers) configured to perform the functions of server 100. Further, while chat server is depicted as including layered query module 111 and prompt modification module 140, in other examples, language server 230 can include one or both of layered query module 111 and prompt modification module 140.

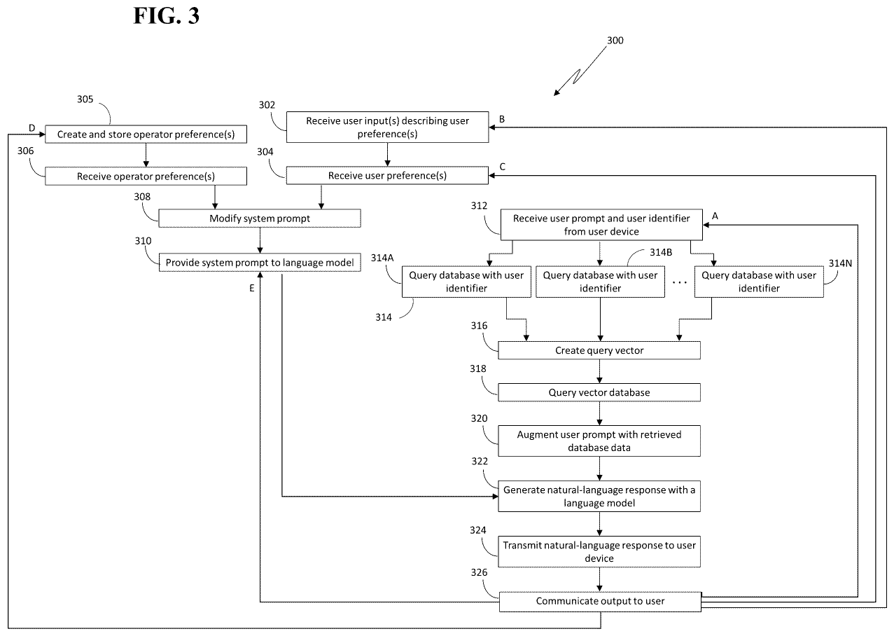

FIG. 3 is a flow diagram of method 300, which is a method of generating and using user-specific system prompts suitable for use with systems 10, 210 (FIGS. 1-2). Method 300 includes steps 302-326 of receiving a user input(s) describing a user preference(s) (step 302), receiving user preference(s) (step 304), creating and storing operator preference(s) (step 305), receiving operator preference(s) (step 306), modifying a system prompt (step 308), providing the system prompt to a language model (step 310), receiving a user prompt from the user device (step 312), querying a database with a user identifier (steps 314A-N), creating a query vector (step 316), querying a vector database (step 318), augmenting the user prompt with the retrieved database data (step 320), generating a natural-language response with a language model (step 322), transmitting the natural-language response to the user device (step 324), and communicating the output to the user (step 326). Method 300 is generally described herein with respect to the devices of system 10 (and the same, functionally equivalent, and/or similar devices of systems 210), but method 300 can be performed using any suitable system to confer advantages related to user-specific system prompts. FIG. 3 also includes arrows A-E, which represent different iteration options for method 300.

In step 302, server 100 receives a user input describing a user preference. The input can be submitted via one or more input devices (e.g., input device 158) and/or user interface devices (e.g., user interface 156) of a user device and can be used by preference management application 180 to define user preferences in subsequent steps of method 300. The input(s) can be any suitable input(s) and, in some examples, can target one or more graphical objects (e.g., of graphical objects 192A-N) of a graphical user interface (e.g., graphical user interface 190). The graphical objects can be, for example, one or more checkboxes that are selectable by the user (e.g., by using a pointer or cursor controlled by an input device). The input device can be, for example, a mouse, a keyboard, and/or a touchscreen, among other options. In some examples, the input can be a user-provided a natural-language text string detailing and/or describing the user's preferences. Any number of inputs can be received in step 302 defining any number of user preferences.

The user preference can be stored to the user device, to server 100, and/or one or more of databases 182A-N (or another suitable device connected to network 188) for further use with method 300 and/or with additional iterations of method 300. The user preference can be stored as, for example, data representative of the user preference. The user preference can be stored as a natural-language representation of the user preference. Additionally and/or alternatively, the user preference can be pre-encoded for use by a language model in subsequent steps of method 300 and the encoded form of the user preference can be stored in step 302. The user preference can be encoded as, for example, one or more tokens representative of the user preference. Any number of user preferences can be stored according to the number of user preferences defined in step 302. In some examples, the user preference information can be organized and/or arranged in a format suitable as a system prompt for a natural-language model, and can be stored in that format and/or as an encoding representative thereof. User preference information can also be optionally stored temporarily to a memory of the user device and then subsequently transmitted to server 100 to be stored for use with further steps of method 300. User preference information can also be optionally transmitted and stored to one or more of databases 182A-N for further use with further steps of method 300.

Step 302 is optional and is performed in examples of method 300 where it is advantageous for a user to define the user's preferences. In some examples and particularly where user preferences are unknown, it may be suitable for a user to define the user's preferences. In other examples, such as where the user's preferences are known and/or where another entity (e.g., an entity operating the server that runs a chat service and/or language generation) knows of or prefers to define user preferences, step 302 can be omitted and user preferences can be defined by the non-user entity.

In step 304, server 100 receives user preference information. Server 100 can receive user preference information from, for example, from the user device (e.g., user device 150), by recalling user preference information from memory 104 of server 100, and/or by retrieving user preference information from one or more of databases 182A-N. Server 100 can receive user preference information by recalling user preference information from memory 104 in examples where server 100 stores user preference information previously provided to a user device and transmitted to server 100. In these examples, method 300 can optionally omit step 302 and can begin from step 304. Server 100 receives user preference information as natural-language text (including as an electronic indication thereof) and/or as an encoding representative of the natural-language text (including as an electronic indication thereof). The preferences can, in some examples, be received as a pre-generated system prompt descriptive of and/or reflective of user preference information. In some examples, additional user preference information received outside of step 302 (e.g., provider-supplied user preferences) can be received in addition to or alternatively to the user preferences received in step 302. Advantageously, receiving user preference(s) as encodings (e.g., tokens) in step 304 reduces computational load on server 100 associated with encoding (e.g., tokenizing) natural-language information representative of the user preference(s).

User device 150 and/or server 100 can, for example, generate natural language representative of user preference information based on inputs from a user to a graphical user interface operated by user device 150 (e.g., graphical user interface 190). User device and/or server 100 can be configured to automatedly and/or automatically generate natural-language and/or an encoding representative thereof that corresponds to the preferences indicated by the user in the graphical user interface. Additionally and/or alternatively, a user can select, indicate, describe, etc. user preference information in natural language provided to user device 150 (e.g., via a user interface device, such as a keyboard or touchscreen). User device 150 and/or server 100 can be configured to remove filler words from the user-provided natural language using, for example, one or more natural language processing models configured to identify and/or remove filler language and/or a machine-learning language model to generate a natural-language summary of the user-provided natural language.

In step 305, operator preference(s) are created and stored. Operator preference information can be defined by the operator of the chat service of chat service module 110 and stored to one or more of databases 182A-N. An operator can manually define operator preference data for prompt modification module 140 and/or can use a software application of server 100 and/or another suitable device connected to server 100 or network 188 to define operator preference(s). In some examples, an operator of server 100 can define operator preferences on a user-by-user or group-by-group basis, allowing the operator to differentially define operator preferences for specific individual users and/or specific groups of individual users. Operator preference(s) can be stored as natural-language text, as one or more encodings representative of operator preference(s), and/or as another suitable type of data representative of natural-language text describing operator preference(s).

In step 306, server 100 receives operator preference information. Server 100 can retrieve operator preference information from the location (i.e., device, system, etc.) to which operator preference is stored. For example, if operator preference information is stored to memory 104, server 100 can receive operator preference information by recalling the operator preference information from memory 104. As an additional example, if operator preference information is stored to one or more of databases 182A-N, server 100 can query the relevant database(s) to receive operator preference information. In some examples, operator preference information can be received from a database (e.g., one or more of databases 182A-N) by querying the database with a user identifier for the user for which user preferences were received in step 304 (i.e., the user that submitted the prompt in step 312, discussed subsequently).

In step 308, server 100 modifies system prompt 130 to language generation based on the user preference information received in step 304 and operator preference information received in step 306. System prompt 130 can be modified by, for example, augmenting a pre-existing system prompt (e.g., a default system prompt) with user preference information received in step 304 and operator preference information received in step 306. Additionally and/or alternatively, the system prompt can be modified by replacing some or all of the pre-existing system prompt (e.g., a default system prompt) with new system prompt information based on the user preference information received in step 304 and the operator preference information received in step 306.

In step 310, the system prompt modified in step 308 (e.g., system prompt 130) is provided to language model 120. The system prompt can be provided as an initial set of instructions and/or as an initial query to language model 120. In at least some examples, language model 120 does not generate natural language in response to the system prompt provided in step 310. In other examples, language model 120 can generate natural language responsive to the system prompt, but that natural language is not provided to the user via chat application 170.

In step 312, server 100 receives a prompt and a user identifier from user device 150. The prompt is natural-language text (e.g., a text string) that includes a natural-language representation of one or more user questions and/or statements for prompting natural-language generation by language model 120. A user can enter a message composed at least partially of the question(s) and/or statement(s) into a chat application configured to interact with and use functionality of server 100 (e.g., chat application 170), and the chat application can provide the message to server 100. The received message can be used as the prompt received in step 312. In some examples, server 100 can remove portions of the user message, such as extraneous filler words, and use the resulting natural-language text as the prompt.

The user identifier can be, for example, an account name, an access credential (e.g., a username), an account number, the user's personal name (e.g., a first and/or last name), etc. In some examples, a user can submit access credentials (e.g., a username, password, etc.) to the chat client and the chat client can verify that the user is approved to access server 100 functionality by validating the provided credentials with credentials stored to server 100. The chat client can store or retain an identifier for the user and can provide that identifier as the user identifier with prompts submitted by the user to server 100.

After step 312, method 300 proceeds to one or more of steps 314A-N. Steps 314A-N are collectively referred to herein as “steps 314” and steps 314A-N are individually referred to herein as a “step 314.” In each of steps 304, server 100 queries a structured or semi-structured database to retrieve user-specific information, such as identifying information for the user, one or more recent purchases made by the user, an account type and/or level held by the user, user financial information, etc. While FIG. 2 shows three steps 314 (i.e., steps 314A, 314B, 314N), method 300 can include any number steps 314. In some examples, method 300 can include only a single step 314, such that server 100 only queries a single database with the user identifier. The number of steps 314 included in method 300 can be selected according to the number of database queries desired to be performed.

In step 316, a query vector is created using the user prompt received in step 312 and the database information retrieved in step(s) 314. Creation of a query vector can be performed by either server 100 or the vector database. Server 100 can create the query vector by creating a vector embedding representative of the user prompt and one or more information elements retrieved in step(s) 314. Some or all of the information retrieved in step 314 can be used to create the query vector in step 316. Server 100 can then query the vector database with the query vector. Additionally and/or alternatively, server 100 can provide the user prompt and at least some of the information retrieved in step(s) 314 to the vector database, and the vector database can create a vector embedding of the prompt and the provided database information.

In some examples, it may be advantageous to retrieve more information from databases in step(s) 314 than is used to create the query vector in step 316. For example, if the information represented in the database vectors is not related to some of the information retrieved in step(s) 314, including that information in the query vector can decrease the relevancy of information returned from a vector database query using the query vector. However, in yet other examples, it can be advantageous to represent all information retrieved in step(s) 314 in the query vector. In all examples, the query vector is an embedding of the user prompt and at least some of the information retrieved in step(s) 314.

In step 318, server 100 queries the vector database with the query vector created in step 316. Querying the vector database in step 318 identifies one or more database vectors having a sufficient similarity to the query vector. The vector database can use any suitable similarity test and any suitable similarity threshold for identifying similar vectors. The similarity test can be, for example, a cosine similarity test, a cartesian similarity test, etc. The vector database can then retrieve the natural-language text strings represented by the identified vector embeddings and provide those text strings to server 100 for further use with method 300.

The vector database queried in step 318 can store vector representations of any relevant natural-language text information. For example, the vector database can store usable templates, forms, etc. that can be used by a language model during subsequent step 322. In yet further examples, the vector database can store vector representations of a user's chat history. The chat history can include, for example, one or more messages sent by the user as prompts and/or returned by server 100 as responses. Advantageously, providing portions of a user's chat history as context to a language model can increase the relevance of language model-generated response text. Further, querying a database storing vector embeddings of a user's chat history can allow for select portions of a user's chat history to be used to provide context during response generation (i.e., during subsequent step 312), reducing computational costs as compared to examples where a user's entire chat history is used as context for each prompt submitted by a user. Querying vector database 184 (step 308) retrieves non-vectorized (e.g. natural language) text corresponding to database vectors satisfying vector similarity criteria with query vectors, as discussed above.

In step 320, server 100 augments the natural-language prompt with data retrieved in step(s) 314 and the data retrieved in step 316. Server 100 can augment the natural-language prompt by adding natural-language representations of the information retrieved in step(s) 318 as well as the natural-language text string(s) retrieved in step 318 to the user prompt received in step 312. In some examples, server 100 augments the natural-language prompt using only the information retrieved in step 318, and in other examples server 100 augments the natural-language prompt using the information retrieved in step 318 and one or more of steps 314.

In step 322, language model 120 of server 100 generates a natural-language response based on the augmented natural-language prompt generated in step 320. The augmented user prompt can be provided to language model 120 as natural language and/or as an encoding representative thereof. In examples where the user prompt is provided as an encoding representative of natural language (e.g., as one or more tokens), server 100 and/or user device 150 can generate the encoding based on the natural language of the user prompt. Language model 120 generates a natural-language output and/or an encoding representative thereof based on the user prompt. The natural-language output can be stored to, for example, memory 104 and used with further steps of method 300. In some examples, server 100 can query one or more databases (e.g., database 182A-N) based on the user prompt, the user's preference(s), and/or the operator's preference(s) as part of a context-injection approach to language generation (e.g., retrieval-augmented generation).

In step 324, the output generated in step 322 is transmitted from server 100 to user device 150. The output can be transmitted as, for example, one or more packets via network 188. Server 100 can be configured to automatically transmit the output to user device 150 after step 314.

In step 326, user device 150 communicates the output generated in step 322 to the user operating the user device. User device 150 can provide an indication of the output to the user, such as displayed text of the natural-language output, spoken audio of the natural-language output, etc.

After step 326, method 300 can proceed via any of arrows A-E to steps 302, 304, 305, 310, and 312. Method 300 can proceed to step 312 (i.e., via arrow A) where a user's preference information does not need to be updated prior to further natural-language generation for that user. Method 300 can proceed to step 302 (i.e., via arrow B) in examples where a user modifies the user's preference information stored by preference management application 180 after reviewing an output from language model 120 communicated in step 326. Method 300 can proceed to step 304 (e.g., via arrow C) in examples where the user preference information is no longer stored by server 100 (e.g., due to a server restart, etc.) and/or the language model, system, and/or server performing language generation is changed following an iteration of step 326. For example, one iteration of steps 308-326 can be performed using a first language model by providing user preferences and modifying a system prompt stored by the system and/or server operating the first language model, and an additional iteration of step 308-326 can be performed using a second language model by again providing user preferences and modifying the system prompt used by the system and/or server operating the second language model. In these examples, step 306 can optionally be performed again to provide server 100 with an additional copy of operator preferences. Method 300 can proceed to step 305 (e.g., via arrow D) in examples where an operator modifies or desires to modify operator preference information. In at least some examples, method 300 can proceed to both steps 302 and 305 following step 326 (i.e., via both arrows B and D) to generate a new natural-language output based on updated user preferences and updated operator preferences. Method 300 can proceed to step 310 (e.g., via arrow E) in examples where the user-specific system prompt will no longer be included in a language model's context window to generate language based on a subsequently-provided user prompt. In these examples, method 300 can proceed to step 310 to provide another copy of the system prompt to the language model prior to providing the new user prompt to the language model in step 314. Examples of method 300 that iterate according to arrow E can also include an additional iteration of step 312 (e.g., via arrow A).

Steps 302-310 of method 300 advantageously provide a method of generating system prompts based on both user and operator preferences. As described previously, incorporating user preferences into a system prompt improves the relevance of outputs generated by a language model to the user and to the prompts submitted by the user. Improving user-relevance of the outputs of a language model can improve user experience when using the language model and can, accordingly, improve user retention of a service for accessing functionality of the language model. Incorporating operator preferences into system prompts can improve the relevance of outputs from a language model to operator goals, desires, and preferences. Method 300 advantageously allows for the automated generation of system prompts based on both user and operator preferences, enabling language generation by a machine-learning language model that both relevant to user interests and relevant to operator goals, desires, etc.

Steps 312-322 of method 300 advantageously use a layered query approach to perform context injection (e.g., RAG) to enhance language model prompts and reduce the occurrence of hallucinations or fabrications in language model outputs. Method 300 provides the same advantages as described previously with respect to server 100 and layered query module 120 (FIG. 1). Notably, method 300 can be used to reduce computational cost associated with context injection approaches to hallucination and/or fabrication reduction (e.g., RAG), by using user-specific information (i.e., information retrieved in step(s) 314) to improve the relevance of information retrieved from a vector database (i.e., in step 318). As such, method 300 can be used to decrease the quantity of information (i.e., the quantity of text) provided to a language model for response generation by improving the likelihood that information used for context is user-relevant. Reducing the size of an input to a language model can decrease the computational load required to generate an output and, further, can thereby reduce the time required to produce the output. In examples where inputs to a language model are token-limited, method 300 can improve the likelihood that information included as context is relevant to a user's prompt. Further, as discussed previously with respect to server 100 and layered query module 111 (FIG. 1), method 300 can also be used to decrease computational cost associated with vector database queries.

While method 300 has been described herein generally with respect to systems, 10, 210, method 300 can be performed in any suitable system and adapted for a wide variety of language models.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of natural language generation, the method comprising:
receiving, by a user device, an indication of at least one user preference for a user, the at least one user preference indicative of at least one first characteristic, preferred by user, of natural-language outputs generated by a machine-learning language model based on natural-language text inputs;
receiving, by the server and from the user device, the at least one user preference;
modifying, by the server, a system prompt for the machine-learning language model based on the received at least one user preference to generate a modified system prompt;
providing, by the server, the modified system prompt as an initial input to the machine-learning language model;
receiving, by a server and from the user device, a natural-language text prompt and a user identifier for the user, the natural-language text prompt provided by the user to a chat application operating on the user device;
querying, by the server, a first database with the user identifier to retrieve first information;
generating, by the processor, a representation of the first information and the natural-language prompt;
querying, by the processor, a second database using the representation to retrieve second information;
generating a modified text prompt based on the natural-language prompt, the first information, and the second information;
providing, by the server and after providing the modified system prompt, the modified text prompt as an input to the machine-learning language model to generate a natural-language text output;
transmitting, by the server, the natural-language text output to the user device; and
causing, by the user device, the chat application to communicate the natural-language text output to the user.

2. The method of claim 1, wherein
the representation is a vector embedding,
the second database is a vector database comprising a plurality of vectors,
each vector of the plurality of vectors representative of a text segment of a plurality of text segments, and
the second information comprises at least one text segment of the plurality of text segments.

3. The method of claim 2, and further comprising receiving at least one first operator preference indicative of at least one second characteristic, preferred by an operator of the server,
of the natural-language outputs, wherein modifying the system prompt comprises modifying the system prompt based on the received at least one user preference and the at least one first operator preference to generate the modified system prompt.

4. The method of claim 1, wherein:
the vector database comprises a plurality of partitions of vector data;
querying the second database using the representation comprises:
selecting a partition of vector data of the plurality of partitions of vector data based on the user identifier; and
comparing the vector embedding to vectors of the partition of vector data to retrieve the second information.

5. The method of claim 1, wherein receiving the at least one first operator preference comprises querying, by the server, a first database using the user identifier to retrieve the at least one first operator preference.

6. The method of claim 1, and further comprising receiving at least one second operator preference indicative of at least one third characteristic, preferred by the operator of the server, of the natural-language outputs, wherein modifying the system prompt comprises modifying the system prompt based on the on the retrieved at least one user preference, the at least one first operator preference, and the at least one second operator preference to generate the modified system prompt.

7. The method of claim 6, wherein receiving the at least one second operator preference comprises querying, by the server, a second database using the user identifier to retrieve the at least one second operator preference.

8. The method of claim 7, wherein the at least one second preferred characteristic comprises an operator-preferred vendor and the at least one third preferred characteristic comprises an operator-preferred data source for context injection.

9. The method of claim 8, wherein the at least one user preference is at least one of a membership, a subscription, a user-preferred vendor, an advertisement preference, and a user-preferred data source for context injection.

10. The method of claim 1, and further comprising querying, by the processor, a third database with the user identifier to retrieve third information, and wherein generating, by the processor, the vector embedding comprises a generating a vector embedding representative of the first information, the third information, and the natural-language prompt.

11. The method of claim 10, wherein:
the first database is configured to store data according to a first database management system; and
the third database is configured to store data according to a second database management system.

12. The method of claim 1, and further comprising encoding, before receiving the at least one user preference, the at least one user preference to at least one memory of the user device based on at least one input received by a user interface of the user device, wherein receiving the at least one preference comprises retrieving the at one preference from the at least one memory.

13. The method of claim 12, wherein:
encoding the at least one user preference to the at least one memory comprises:
generating at least one token representative of the at least one user preference using a tokenizer algorithm configured to generate input tokens usable by the machine-learning language model; and
storing the at least one token to the at least one memory, and
retrieving the at least one user preference comprises retrieving the at least one token.

14. The method of claim 13, wherein:
generating the at least one token comprises generating the at least one token upon receiving the at least one input,
storing the at least one token to the at least one memory comprises storing the token upon generating the at least one token, and
retrieving the at least one token from the at least one memory comprises retrieving the at least one token after an inactive period, wherein:
the inactive period follows storing the at least one token, and
the chat application does not receive any user prompts during the inactive period.

15. The method of claim 14, and further comprising updating the at least one user preference, before receiving the at least one user preference, based on at least one additional input received by the user interface of the user device.

16. The method of claim 1, and further comprising requesting, by the server, the at least one user preference from the user device upon receiving the natural-language text prompt.

17. The method of claim 16, and wherein querying the first database comprises querying the first database upon receiving the natural-language text prompt and wherein querying the second database comprises querying the second database upon receiving the natural-language text prompt.

18. The method of claim 17, wherein generating the at least one user preference comprises generating a first natural-language word based on the at least one input.

19. The method of claim 17, wherein the at least one first operator preference comprises a second natural-language word.

20. A system for natural language generation, the system comprising:
a first database configured to store first user-specific information;
a second database configured to store a plurality of vector embeddings representative of a plurality of natural-language text segments, each vector embedding of the plurality of vector embeddings representative of one natural-language text segment of the plurality of natural-language text segments;
a user device comprising:
a first processor; and
at least one first memory encoded with first instructions that, when executed, cause the first processor to:
receive at least one input indicative of a natural-language text string; and
provide the natural-language text string as a natural-language text prompt to a chat application operating on the user device; and
a remote device communicatively connected to the user device, the remote device comprising:
a second processor; and
at least one second memory encoded with second instructions that, when executed, cause the second processor to:
receive the natural language text prompt from the user device;
receive at least one user preference indicative of at least one first characteristic, preferred by a user, of natural-language outputs generated by a machine-learning language model based on user-provided natural-language text inputs;
receive at least one first operator preference indicative of at least one second characteristic, preferred by an operator of the server, of the natural-language outputs;
modify a system prompt for the machine-learning language model based on the at least one user preference and the at least one first operator preference;
provide the system prompt as an initial input to the machine-learning language model;
query the first database with the user identifier to retrieve first information;
generate a vector embedding representative of the first information and the natural-language prompt;
query the second database using the vector embedding to retrieve second information;
generate a modified text prompt based on the natural-language prompt, the first information, and the second information;
provide, subsequent to providing the system prompt, the modified text prompt as an input to the machine-learning language model to generate a natural-language text output; and
transmit the natural-language text output to the user device.
